(19) United States
(12) Patent Application Publication
(10) Pub. No.: US 2011/0056568 A1
(43) Pub. Date: Mar. 10, 2011

(54) Method and Apparatus for Diverting Flowing Liquid from a Conduit

(75) Inventor: Richard Warren Jones, Abingdon (GB)

(73) Assignee: HYMETRICS LIMITED, Oxford, Oxfordshire, GB (GB)

(21) Appl. No.: 12/991,437

(22) PCT Filed: May 7, 2009
(86) PCT No.: PCT/GB2009/050478

§ 371 Date: Nov. 7, 2010

(30) Foreign Application Priority Data
May 8, 2008 (GB) 0808346.1

(51) Int. Cl. F15D 1/00

(52) U.S. Cl. 137/1; 137/558; 137/237

(57) ABSTRACT

A compact system is provided for diverting excess flow of liquid such as waste water from a conduit and to retain debris within the conduit. This incorporates a control section (22), which may be generally cylindrical, and arranged to be rotatable about a longitudinal axis (23), and defining a discharge port (24) through which excess water can leave the conduit. In operation, the depth of water in the conduit would be measured (15) downstream of the control section (22), and the rotation of the control section (22) adjusted in accordance with whether the water surface is above or below a depth limit. The discharge port (24) may include a grille to retain any debris, and the apparatus may include brushes (27), scrapers (29) or water jets (26) to dislodge any material held on the grille when the discharge port is at a top centre position.

The present invention relates to a method and an apparatus for diverting flowing liquid from a conduit, for example if there is an excess of flow along the conduit.

In this field, which is particularly relevant to the control of waste water, some exemplary devices are described in:

“Device for removing debris from a flowing sewage liquid” EP0259547, Huber, Hans-Georg

### “Rotary Screen”

### GB2241905, Eden, Keneth Albert

“Sewage flow control system”

### KR20020057668, Lee, Gwon Jae

Wastewater flowing in drains and sewers often becomes combined with rainfall. In periods of heavy rainfall, the additional volume flowing in these conduits may exceed their capacity. When this happens, a portion of the flow must be diverted from the conduit to prevent wastewater backing and emerging from entry points and at manholes. Excess flow is diverted from the conduit into a nearby watercourse such as a river or canal.

A system for diverting excess flow in a sewer is called a sewer overflow. They are required to keep debris, especially floating material, within the sewer, and not allow such material to reach natural watercourses. This can be done by mechanical screens but this requires motorised equipment.

Conventional sewer overflows take the form of a spill-crest running horizontally along a length of the conduit at a level of typically 0.8 times the drain diameter above the invert of the drain (i.e. the lowest level in the drain). This causes the flow to spill from the drain when its level exceeds 0.8 times the diameter. Debris is mechanically screened in a spillway and returned to the drain to pass downstream with the retained flow. From the spillway, the excess flow discharges into the overflow channel leading to, for example, a river. This arrangement requires long crests to allow large volumes to be diverted with the limited head available in the conduit above the crest.

Although simple, these conventional systems have drawbacks:

1. They occupy a significant length of sewer. Sewers are normally underground and therefore, to install them is costly.
2. The arrangements for screening and returning debris to the sewer are elaborate and prone to failure.
3 The scope for control of the flows is determined by the cost which usually means that conventional systems can divert a limited portion of excess flow. These systems can be overwhelmed by storm surges.

An active system incorporates a motorised gate to allow a higher portion of the flow to be diverted. The conduit cross-section is adapted to a rectangular section. The motorised gate is installed on a vertical wall of the rectangular section. Controlled sewer overflows require a means of measuring the depth of water downstream of the gate so that the gate position can be continuously varied to limit the downstream depth to a predefined level.

Sewers running at near-full capacity are designed to have flow velocities of 0.8 to 1.0 m/s which usually means the hydraulic conditions are close to a critical state determined by a parameter known as the Froude number. At the critical state, small disturbances of the water surface in the channel can cause significant variations in the capacity of the conduit. Furthermore, as the water level approaches the roof of the drain, the flow capacity diminishes: maximum capacity occurs at 94% of the diameter. This induces a further mode of instability in which the flow alternates with surging oscillations. Such oscillations cause problems in controlling the gate position. These conditions make the measurement of downstream depth in the conduit technically difficult. Unless water level can be measured reliably, control of the flow cannot be assured.

The object of this invention is to achieve a compact system for diverting excess flow in wastewater conduits to provide precise and stable control, and to retain debris within the conduit.

### SUMMARY OF THE INVENTION

The above and other objects of the invention are achieved by a control section of conduit arranged to rotate about an axis, the control section communicating with upstream and downstream portions of the conduit and supported for rotation about an axis, the control section defining a discharge port through which liquid such as water may be discharged from the conduit.

The method comprises determining the flow of the liquid in the conduit to determine if the flow is above or below a flow limit, and:

if the flow of liquid is above the flow limit, causing the control section to rotate about the axis to move the discharge port to progressively lower positions to cause liquid to commence discharge from the conduit or to increase the discharge of liquid from the conduit;

if the flow of liquid is below the flow limit, causing the control section to rotate about the axis to move the discharge port to progressively higher positions to cause the discharge of liquid from the conduit to be reduced or to cease.

If the flow or depth of liquid (e.g. water) persists at a level below a flow or depth limit, the method may involve causing the control section to rotate about the axis to a parked position at which the discharge port is at the top of the control section.

The discharge port preferably incorporates a grille of bars to prevent any debris carried by the water being discharged, and the method preferably comprises periodically moving the control section to this parked position, in which the discharge port and so the grille is at the top of the control section, to allow any debris on the grille to fall back into the water flowing in the conduit.

In a further modification two or more such control sections may be arranged in series, and may be controlled by a common controller. For example when one control section is in the parked position to allow trapped debris to fall back into the liquid in the conduit, the other control section may be moved into the outflow position, so that there is no buildup of water level in the conduit.

### BRIEF DESCRIPTIONS OF THE DRAWINGS

The invention will now be further and more particularly described, by way of example only, and with reference to the accompanying drawings in which:

FIG. 1a shows a perspective view of a conventional system for limiting a flow of water in the conduit;

FIG. 1b shows a cross-sectional view of the system shown in FIG. 1a;

FIG. 2a shows a perspective view of a prior art system with an actuated gate;

FIGS. 2b & 2c show sectional views of the system of FIG. 2a with the gate in the closed and open positions, respectively;

FIG. 3 shows a perspective view of a system in accordance with the invention with a control section of the conduit that can be rotated about an axis;

FIGS. 3a to 3e show cross-sectional views of the control section of the system of FIG. 3 at different degrees of rotation

FIG. 3f shows a perspective view of the system of FIG. 3 with the control section in a different position;

FIG. 4 shows a modification to the system of FIG. 3 with grille and grille-cleaning brushes and with nozzles for water-jet back-flushing of the grille;

FIGS. 4a to 4e show cross-sectional views of the arrangement of FIG. 4 at different degrees of rotation;

FIG. 5 shows a cross-sectional view of an alternative modification to the system of FIG. 3 with grille and grille-cleaning scraper and with nozzles for water-jet back-flushing of the grille; and

FIGS. 5a to 5f show cross-sectional views of the arrangement of FIG. 4 at different degrees of rotation.

### DESCRIPTION OF THE INVENTION

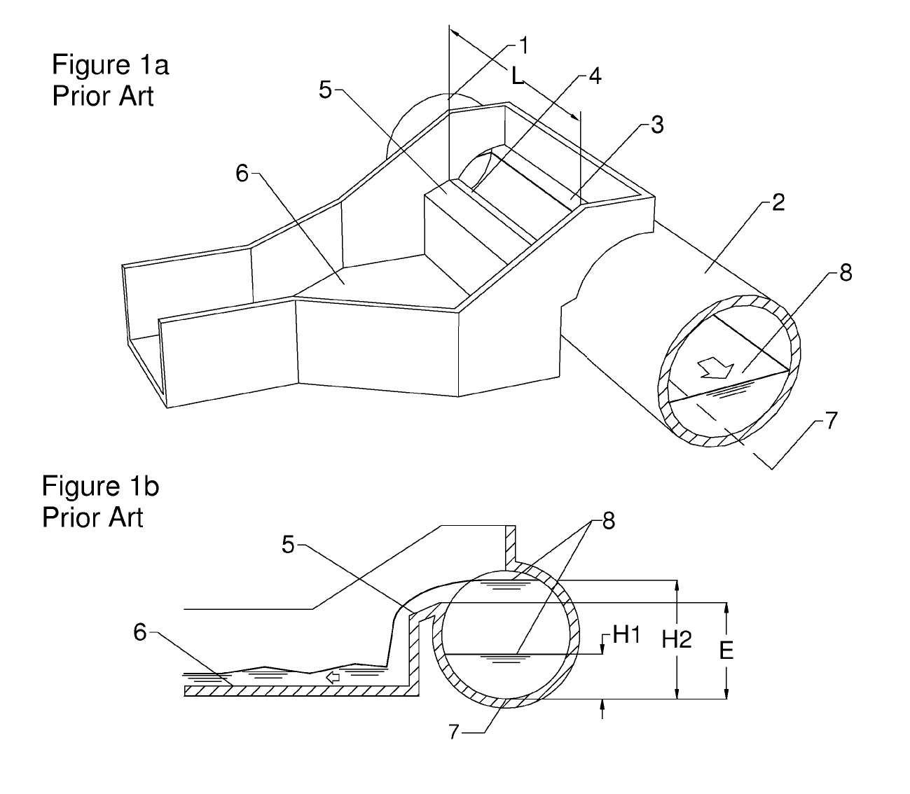

Referring to FIGS. 1a and 1b, there are shown sections of a conduit of circular cross-section for carrying wastewater with an upstream section 1 and a downstream section 2 of the conduit between which there exists a control section 3 with a horizontal discharge crest 4 and with discharge chute 5 to carry any discharged wastewater to a spillway 6 which then leads the discharge to a receiving watercourse, not shown, such as a river or canal. The discharge crest 4 is at an elevation E above the invert line 7 of the conduit (that is to say the bottom of the conduit).

Water flowing along the conduit at a level H1 relative to the invert line 7, remains in the conduit because it is below the discharge crest 4. If the water level rises to H2 above the crest elevation E then a portion of the flow from the upstream section 1 will be discharged over the crest 4. This discharge is related approximately by:

Discharge=KL(H2−E)^{1.5}

where L is the horizontal length of the crest and K is a constant.

The surface of the water 8 drops as the flow passes along the crest 4. This means that that this type of system can only limit the water level approximately in the downstream section 2 because the discharge decreases asymptotically as H2 decreases along the discharge crest 4. In practice, the crest length, L, is made as long as possible, subject to cost limitations. Often, two discharge crests are constructed on opposite sides of the drain with separate chutes leading the discharges to a common spillway below the conduit.

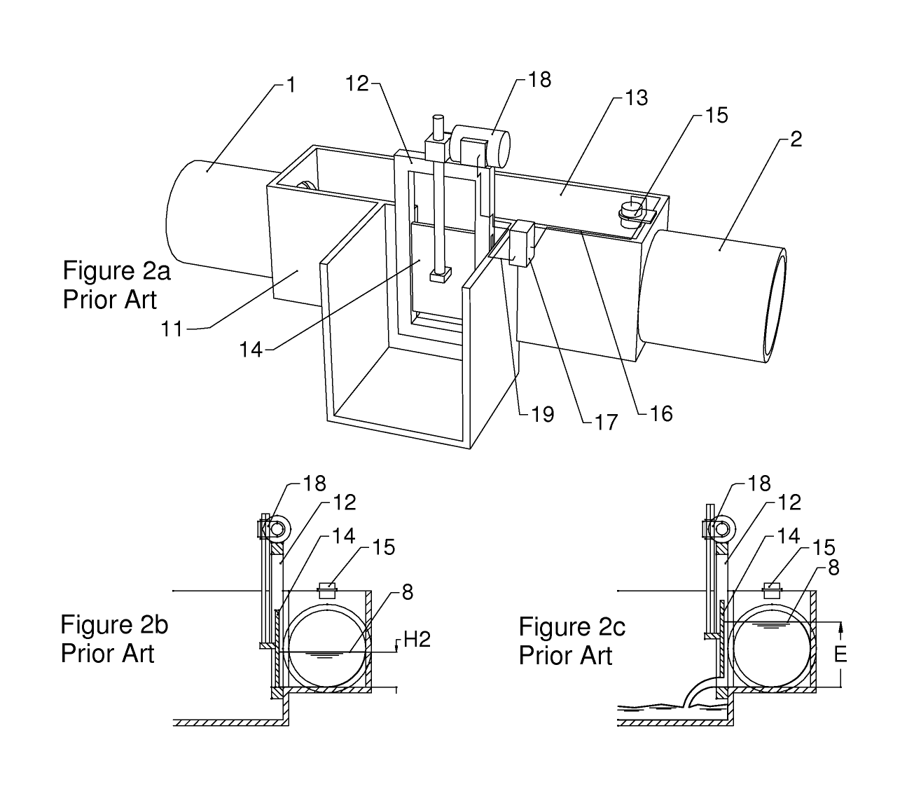

Referring now to FIGS. 2a, 2b and 2c, these show a drain overflow system with an actuated gate. The conduit has an upstream section 1 and a downstream section 2 with a rectangular chamber at a control section 13. An actuated gate 14 is located in a vertical side wall 11 of the control section 13 and is incorporated in a penstock frame 12. The gate 14 is raised vertically to allow water to flow underneath it. In an alternative, the gate 14 might instead be lowered vertically to allow excess water to flow over it.

A sensor 15 is located close to the downstream section 2 to monitor the level H2 of the water surface 8. The type of sensor 15 shown in FIG. 2a and is an air-ranging ultrasonic level measurement sensor. A signal representing the water level is communicated via line 16 from the sensor 15 to a control unit 17 which positions the gate 14 via the control line 19 to the actuator 18 according to the sensed water level H2. When the water level exceeds the required limit in the downstream section 2, the control unit 17 causes the gate 14 to be gradually opened by a few millimetres by actuator 18. When the water level falls below the required limit, E, the control unit 17 moves the gate 14 towards its closed position.

This arrangement can be constructed in a much more compact form than that of FIG. 1, because there is greater control over the outflow rate. It therefore is more cost-effective especially when the system is to be installed underground. It also has the advantage of being able to regulate the water level to the predefined limit, E.

Another arrangement, not illustrated herein, is often used at the inlet to sewage treatment works. This uses the conventional arrangement of FIG. 1 but with an actuated gate in the conduit of the downstream section. This gate is normally fully open. It is partially closed when it is necessary to restrict the water level in the downstream section. This method has two disadvantages relative to FIG. 2:

the water surface immediately downstream of the gate is severely disturbed by the turbulence caused by water flowing under the gate. The sensor 15 must therefore be located far downstream of the gate to ensure reliable measurement of H2; and

the water level in the upstream section 1 has to be higher than that which would be required by the arrangement of FIG. 2. This normally means that the full-bore of the drain is occupied by flowing wastewater.

This induces cyclic instability making precise control of water level downstream impossible.

Consequently this modification to the arrangement of FIG. 1 with a control gate across the downstream conduit is not only inherently unstable, but would require the installation to occupy a much longer length of the conduit and would therefore be costly.

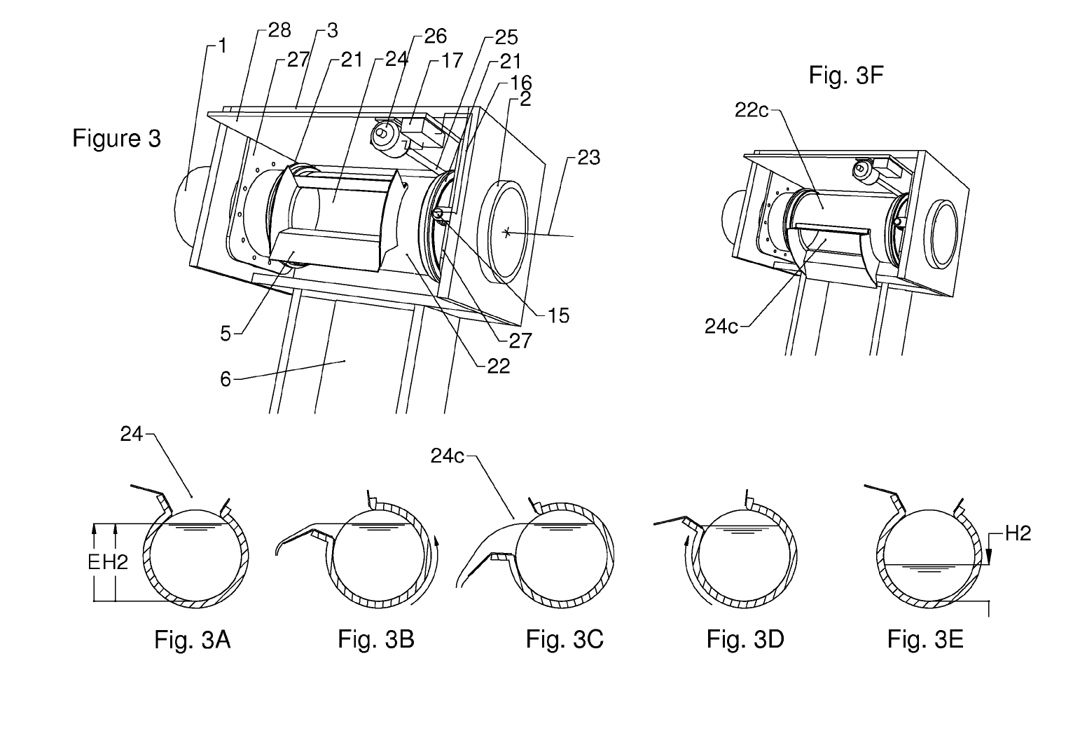

Referring now to FIG. 3, this shows a control apparatus of the invention, incorporating a cylindrical control section 22 of the conduit which can be rotated about the axis 23 while supported in bearings 21. The bearings 21 incorporate seals (not shown) to prevent leakage of water from the conduit. A discharge port 24 in the circumference of the control section 22 can be rotationally positioned about the axis 23 by a linkage 25 to an actuator 26. In this example the upstream and downstream portions 1 and 2 of the conduit define a longitudinal axis that is co-linear with the rotational axis 23 of the control section 22; and in this example the discharge port 24 is rectangular, with its long axis parallel to the axis 23, and subtending an angle of about 60° from the centre of the cylindrical control section 22.

Flanges 27 couple to spigots on upstream and downstream sections 1 and 2 of the conduit. The flanges 27 form part of a chassis 28 on which the actuator 26 is mounted. The flanges 27 couple with the stationary member of the bearings 21 and the cylindrical control section 22 couples with the rotating member of the bearings 21. Movement of the actuator 26 causes the cylindrical control section 22 to turn around the axis 23, by which the discharge port 24 can be positioned at any circumferentially higher or lower position 24c (as shown in FIG. 3f). To direct discharge from the port 24 to a spillway 6, a chute 5 is affixed to the cylindrical control section 22.

In this example the upstream and downstream sections 1 and 2 of the conduit are cylindrical, and of the same diameter as the cylindrical control section 22; the connections between the flanges 27 and the upstream and downstream sections 1 and 2, and the bearings 21, do not protrude into the cylindrical flow path, so the flow path for the liquid is a continuous cylindrical channel without any steps at which debris might be trapped. A further benefit of providing a continuous cylindrical channel of uniform bore for the flowing liquid is that the flow is more stable.

A sensor 15 is located in the downstream section 2 to monitor the water level H2. A signal representing the water level is communicated via line 16 from the sensor 15 to a control unit 17 which positions the cylindrical control section 22 by the actuator 26 according to the sensed water level H2. FIGS. 3a to 3e show sectional views of the control section 22 at different angular positions.

The port is normally parked near to the top-centre position, as shown in FIG. 3e, when the water level H2 is below E. When the water level reached or exceeds the limit E, as illustrated in FIG. 3a, the controller 17 inches the actuator 26 to rotate the control section 22 and to move the discharge port 24 to a lower position to discharge excess flow from the conduit via the discharge port 24, as shown in FIGS. 3b and 3c. Typically the discharge port 24 would be moved in increments of a few millimetres, for example each increment may be less than 10 mm, for example 3 mm or 5 mm, and such a movement would be made in accordance with a measurement of the water level at regular intervals for example every minute or every two minutes (indeed such measurements may be made more frequently if the water level is observed to be close to the required limit). When the water level falls below the required limit, the controller 17 inches the actuator 26 to rotate the control section 22 and so to raise the discharge port 24 to a higher position to reduce the discharge, as illustrated in FIG. 3d.

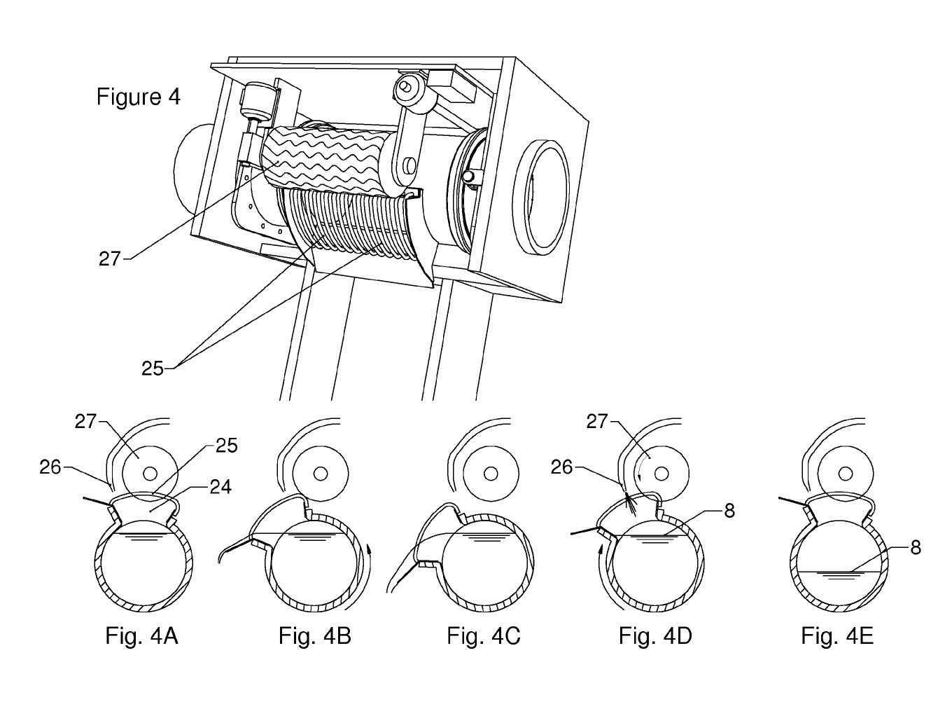

FIG. 4 shows a modification to the system of FIG. 3 with a grille of bars 25 across the discharge port 24 to prevent or inhibit debris from being discharged through the discharge port 24. However, such screens can become blocked by excessive accumulation of debris. A clearing cycle is therefore used to remove any such accumulation. The control section 22 is periodically rotated so that the discharge port 24 is at the top-centre position, as shown in FIG. 4a, where heavier material drops back into the flowing water to be carried downstream. Lighter material can be flushed off the grille by discharge water recirculated under pressure through nozzles 26 as shown in FIG. 4d. The flushing action is synchronised with the return of the discharge port 24 to the top-centre position, as shown in FIG. 4e. The interval between such actions may be a fixed period, such as 5 minutes. However, the period may also be determined by the amount of blockage, indicated by the position of the discharge port 24. A blocked grille would cause the control unit to move the discharge port 24 to its lowest position, a position detectable by a limit switch (not shown) connected to the control unit. In such an event, the control unit would initiate a clearing cycle.

In a further modification, the system may include two such control sections 22 arranged in series, and both these control sections 22 may be controlled by the same controller 17. If the water level exceeds the desired limit E (as shown in FIG. 3a), then one or other of these control sections 22 would be actuated as described above. When one control section 22 is undergoing a clearing cycle as described in relation to FIG. 4a, then the other control section 22 would be actuated to allow discharge of the excess liquid.

The greater part of the bars 25 forming the grille lie on circular arcs outside the cylindrical control section 22 and are centred on the axis of rotation 23. The ends of the bars 25 of the grille are curved towards the axis 23 and are fixed to the control section 22 to allow members, such as fixed brushes or scrapers, external to the control section to extend inside the grille to clear it of debris as the control section 22 is rotated. In this example motorised brushes 27 may be used to clear debris from the grille as the discharge port 24 returns to the top-centre position as shown in FIGS. 4d and 4e. Preferably these motorised brushes 27 are used in conjunction with water under pressure sprayed through nozzles 26.

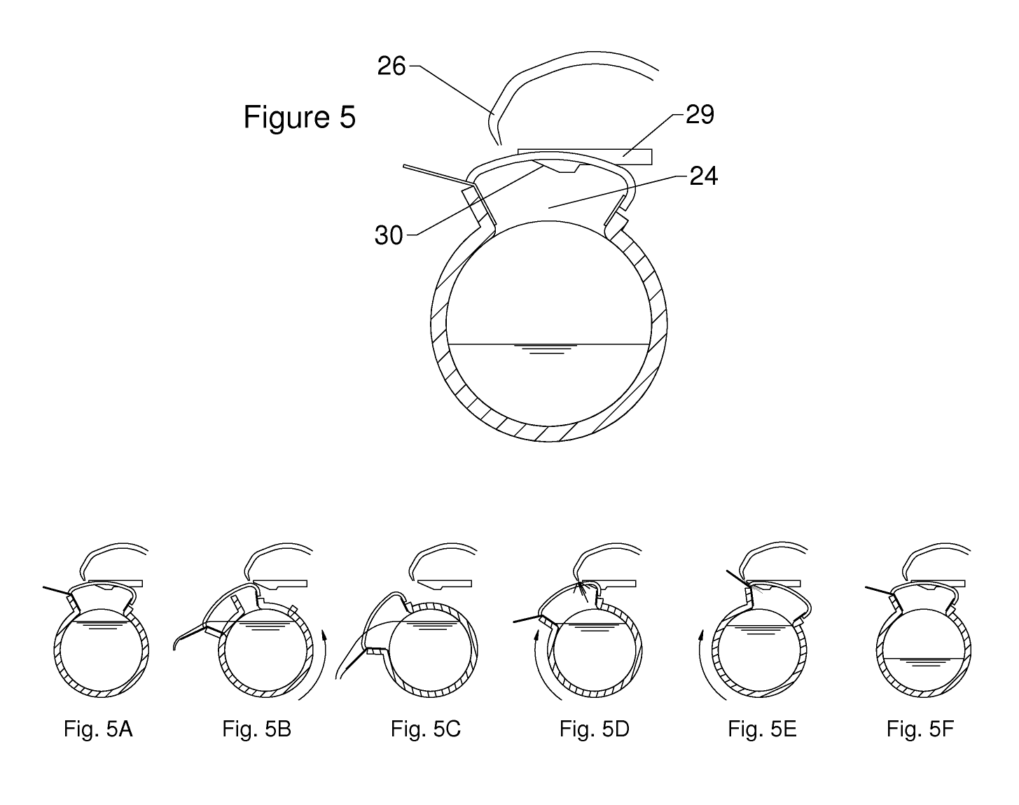

FIG. 5 shows a modification to the system of FIG. 4 in which the motorised brushes 27 are replaced by scrapers 29 interposed between the bars 25 of the grille so that material adhering to the bars 25 is scraped off by the inclined leading edges 30 of the scrapers 29, thence to fall towards the water surface 8.

FIG. 5a shows the system at the limit E prior to controlling the water level 8. FIGS. 5b and 5c show the cylindrical control section 22 rotated to induce discharge through the discharge port 24 thereby effecting control of the water level 8. FIGS. 5d and 5e show the cylindrical control section 22 rotated towards the top-centre position of the discharge port 24 in the to clear any debris from the grille 25. FIGS. 5d and 5e show an optional water jet nozzle 26 assisting the clearing of debris; and FIG. 5f shows the system at a parked position.

It will be appreciated that the apparatus of FIG. 3 and the modifications of FIGS. 4 and 5 are shown by way of example only. The control apparatus may be modified in various ways while remaining within the scope of the invention. For example the control section 22 is shown as being generally of circular cross-section, but it might instead be of generally elliptical cross-section or of U-shaped cross-section; the control section is described as defining a rectangular discharge port 24, but the discharge port might instead be of generally elliptical shape.

What is claimed:

1. A method of controlling a flow of liquid passing along a conduit by means of a cylindrical control section of the conduit arranged to rotate about an axis, the control section communicating with upstream and with downstream portions of the conduit, the upstream and downstream portions of the conduit and the control section being of circular cross-section and defining a flow path for the liquid that is a continuous cylindrical channel without any steps, and the control section being supported for rotation about an axis, the control section defining a discharge port through which liquid may be discharged from the conduit, the method comprising:
determining the flow of liquid in the conduit to determine if the flow of liquid is above or below a flow limit; and
if the flow of liquid is above the flow limit, causing the control section to rotate about the axis moving the discharge port to progressively lower positions to cause liquid to commence discharge from the conduit or to increase the discharge of liquid from the conduit;
if the flow of liquid is below the flow limit, causing the control section to rotate about the axis moving the discharge port to progressively higher positions to cause the discharge of liquid from the conduit to be reduced or to cease.

2. A method according to claim 1 in which the determination of the flow of liquid and definition of the flow limit is by means of determining the depth of liquid and defining a depth limit downstream of the control section.

3. A method according to claim 1 comprising, if the flow of liquid persists at a level below the flow limit, causing the control section to rotate about the axis to move the control section to a parked position in which the discharge port is at the top of the control section.

4. A method according to claim 1 in which the control section incorporates a grille of bars over the discharge port to prevent debris carried by the liquid being discharged, the method comprising periodically moving the control portion to a parked position in which the discharge port is at the top of the control section, to allow any debris on the grille to fall back into the flow of liquid.

5. A method according to claim 1 in which, when rotating the control section to move the discharge port, the discharge port is moved in increments, each increment being less than 10 mm.

6. An apparatus for controlling a flow of liquid within a conduit through which liquid flows, the apparatus comprising:
a cylindrical control section for the conduit, the cylindrical control section being adapted to communicate with upstream and with downstream portions of the conduit, the upstream and downstream portions of the conduit and the control section being of circular cross-section and defining a flow path for the liquid that is a continuous cylindrical channel without any steps, and the control section being mounted such that the cylindrical control section can be rotated relative to an axis, and the control section defining a discharge port in the surface of the control section through which liquid flowing within the conduit may be discharged from the conduit;
means for rotating the control section about the axis to position the discharge port relative to the liquid surface;
means for determining the liquid flow within the conduit; and
a control unit, communicating with the means for determining liquid flow, to actuate the means for rotating the control section such that, by varying the position of the discharge port relative to the liquid surface, the discharge of liquid through the discharge port may be varied.

7. An apparatus as claimed in claim 6 wherein the flow measurement means comprises means for determining the liquid level within the conduit.

8. An apparatus according to claim 6 in which the control section incorporates a grille associated with the discharge port to prevent debris carried by the liquid from leaving the conduit.

9. An apparatus according to claim 8 in which the grille comprises a set of bars arrayed on circular arcs centred on the rotational axis of the control section and radially outside the control section, the ends of the bars being adapted to be fixed to opposite rims of the discharge port to allow cleaning members external to the control section to clear the grille of debris as the control section is rotated.

10. An apparatus according to claim 9 in which the cleaning members engage periodically when the discharge port is moved from a discharging position to a position close to the top of the control section to allow debris collected by the grille to be removed from the grille and to drop back into the liquid flowing in the conduit, the periodicity being determined by the control unit either detecting the lapse of a pre-set interval of time or detecting the arrival of discharge port at its lowest position.

11. An apparatus according to claim 8 also comprising liquid spray jets arranged for cleaning the grille.

12. An apparatus as claimed in claim 6 comprising a plurality of said control sections arranged in series for flow of the liquid.
